(19) United States
(12) Patent Application Publication
(10) Pub. No.: US 2024/0329400 A1
(43) Pub. Date: Oct. 3, 2024

(54) SYSTEM THAT PERFORMS MASS PRODUCTION PROCESS ANALYSIS WITH MIXED REALITY GLASSES WITH EYE TRACKING AND ACCELEROMETER

(71) Applicant: SAHINCE OTOMOTIV SANAYI VE TICARET ANONIM SIRKETI, Nilüfer, Bursa (TR)

(72) Inventors: Halil Ibrahim KARAALP, Bursa (TR); Oguzhan ISTANBULLU, Bursa (TR)

(21) Appl. No.: 18/575,099

(22) PCT Filed: May 9, 2022
(86) PCT No.: PCT/TR2022/050406

§ 371 Date: Dec. 28, 2023

(30) Foreign Application Priority Data
Jun. 28, 2021 (TR) 2021/010513

(51) Int. Cl. G02B 27/01; G02B 27/00

(52) U.S. Cl. CPC G02B 27/017; G02B 27/0093

(57) ABSTRACT

Disclosed is a system that enables recording of points on which an operator focuses with his eyes, and the head position and head direction in numerical form through software running on mixed reality glasses. The mixed reality glasses have eye tracking and accelerometer features and create an ideal production scenario by analyzing the sub-processes sequentially during the operation by artificial intelligence.

### TECHNICAL FIELD

The present invention relates to the system to be used in the analysis of serial operations comprising sub-processes performed by humans in areas such as production facilities.

In particular, the present invention relates to a system that enables to record the points on which the operator focuses with his eyes, and the head position and head direction in numerical form through software running on a mixed reality glasses hardware with eye tracking and accelerometer features and to create the ideal production scenario by analyzing the sub-processes sequentially (such as receiving raw materials from the case, placing in the mold, pressing the button, stacking parts in the safe) during the operation by means of artificial intelligence.

### STATE OF THE ART

Today, work study analysis is carried out for the standardization of production processes. The time study and methods engineer videotapes the production to determine the ideal operating scenario of an operation and the duration of the sub-processes in the state of the art. Then, he/she takes note of which process the production operator starts in which second by watching the video recording. As a result of this study, it determines the duration of the sub-processes of mass production. It calculates the ideal unit production time of the operation from the sum of these durations.

For example, for an operation that is performed 10 times during recording, Table 1 and Table 2 are created as follows, and the required durations of sub-processes such as walking, picking parts from the cash register are determined from these 10 production data:

TABLE 1
Sub-process analysis sample worksheet

| Process | Walk | Picking a part | Storage | Position | Button |
|---|---|---|---|---|---|
| 1 | 0.934 | 1.302 | 1.168 | 1.068 | 2.736 |
| 2 | 1.101 | 1.235 | 1.268 | 1.101 | 2.936 |
| 3 | 1.134 | 1.302 | 1.233 | 1.001 | 2.87 |
| 4 | 1.101 | 1.234 | 1.202 | 1.034 | 2.836 |
| 5 | 1.134 | 1.201 | 1.302 | 1.168 | 2.869 |
| 6 | 1.034 | 1.235 | 1.168 | 1.134 | 2.903 |
| 7 | 0.901 | 1.268 | 2.903 | 0.933 | 2.837 |
| 8 | 1.101 | 1.301 | 1.301 | 1.001 | 2.936 |
| 9 | 1.068 | 1.201 | 1.335 | 1.034 | 2.97 |
| 10 | 1.001 | 1.368 | 1.468 | 1.068 | 2.936 |

TABLE 2
Operation analysis result example

| | | | Receiving | | | | | | | |
|---|---|---|---|---|---|---|---|---|---|---|
| | | | and | | Scrap | | Heavy / | | | |
| | | Control / | Leaving | | Collection | | Mass | | | |
| Button | | Quality | the | | & | Temporary | Part | Stepping | Bending | Total |
| Press Process | Positioning | Activities | Part | Storing | Unloading | Placement | Receiving | Walking | Standing | Duration |
| 2.44 | 1.15 | 0.20 | 2.07 | 0.28 | 0.28 | 0.87 | 0.19 | 3.56 | 0.14 | 11.18 |

The time study and methods engineer should increase the number of samples in order to reduce the margin of error. Recording and analysis should be carried out in a way to cover all possible sub-processes that may occur during the relevant operation in order to calculate the analysis values of sub-processes such as lot (lot formed by grouping more than one product-according to differences in production time, personnel, raw material/semi-product, etc.) that do not need to be done in each unit of production or placing parts in the case. For example, if during a production, parts are aligned once in 50 productions and 100 production processes should be recorded in order to keep at least 2 sample records of packing items. Or, instead of a study with a single operator, it may be necessary to record the same operation with different operators and to reflect individual changes in the study.

Calculating the ideal study duration is a time-consuming and difficult process for the time study and methods engineer due to the above mentioned reasons. In addition, it is a time-consuming and error-prone work due to the fact that the work study period analysis consists of recording and evaluating the actions of people based on observation by other people.

Unit production time, which is expressed as work study time, is of critical importance as it directly affects calculations such as cost, productivity and delivery time after it is calculated. For this reason, it is necessary to repeat the study from time to time so as to prevent possible erroneous calculations. Moreover, the work study analysis should be revised after changes such as revisions in the worksite organization or operation steps that may affect the operation process. It is difficult to repeat the study of the same operation for reasons such as analysis confirmation and revision where there is a large variety of operations.

A solution for detection and execution with statistical probability analysis of the operations of the aircraft during the piloting of the aircraft by following the eye movements of a pilot with the aim of reducing the workload of the pilot and improving the human-machine interaction is described in the patent document numbered CN111124124A of the state of the art, Since the aim here is to detect and perform movements beforehand, this structure is not suitable for use in work study for the standardization of production processes.

In the state of the art, in the patent document numbered CN111949131A, it is mentioned that determining the function at the point focused directly with the eye and performing it with the help of blinking or pressing a button. The system mentioned in this application does not have the purpose of intervening the process in order to determine the work of the operator and to speed up the process on the computer side or to make it easier.

In the state of the art, a method is proposed that allows the virtual assembly process to be combined with the functions of tracking the point of view from eye movement data and deep learning techniques from hand-arm movement information and hand-arm movements recognition functions in the patent document numbered CN110362210A. However, eye tracking with deep learning techniques and recognition of hand-arm movements require a lot of data in this method. In addition, although the movements of the people are recognized in the virtual environment, the movements of the people are not analyzed in the real environment and there is no system that analyzes the work performed by the operator.

The invention in the patent document numbered GB201817061D0 relates to a system that assists an employee in performing production tasks in the state of the art. The invention consists of an augmented reality imaging system, a task status detection system that determines the state of the production task, a physiological detection system that detects the physiological state of the worker, and an electronic processing system. It is shown to the employee with an augmented reality imaging system after the work to be done in the system is determined in the electronic processing system according to the physiological state of the employee and the production task situation. In said system, the work status of the employee and the work he/she will do according to his/her physiological state are shown with the augmented reality imaging system, there is no system that analyzes the points that the personnel looks at with the help of artificial intelligence, automatically detects the work done from the position of the employee and the points he/she looks at, and also calculates the unit production time of the employee.

In the state of the art, in the patent documents numbered WO2020129029A3, WO2020087919A1, CN108334185A, US10936057B2, WO2020246986A1, EP3722863A1, US20200218345A1, WO2020102110A8, WO2020122488A1, CN110572632A, EP3552077A1, US10936057B2, EP3722863A1, US20200218345A1, WO2020102110A8, WO2020122488A1, CN110572632A, EP3552077A1, US10936057B2, US08563731, 100080903B, US08563281B, US085639803B, US085635903B, US085635903B, US085635903B, US085635903B, US085635903B, 89535923B, functions of mixed/virtual reality hardware such as hologram display/interaction, eye tracking/calibration or details of the hardware itself are described.

As a result due to the above mentioned disadvantages and the insufficiency of the current solutions regarding the subject matter, a development is required to be made in the relevant technical field.

### Aim of the Invention

The invention aims to solve the above mentioned disadvantages by being inspired from the current conditions.

The main aim of the invention is to create the necessary data for analysis in numerical form as soon as the recording made during the period to be analyzed is finished by recording the operation to be analyzed in digital form by software running on a mixed reality glasses hardware with eye tracking and accelerometer features.

Another aim of the invention is to reduce the margin of error, as the time study and methods engineer does not need to measure the time of all sub-processes one by one.

Another aim of the invention is to save time spent on analysis, as the time study and methods engineer does not need to make time measurements of all sub-processes one by one.

In order to fulfill the above-described purposes, the present invention is a system that enables the creation of a production process by recording and analyzing the points that the operator focuses on with his eyes, and the head position and head direction, it comprises the following;
a mixed reality glasses, which provides the operator's head position, head direction, eye hit position and eye gaze direction in X, Y and Z directions, with the sensors and accelerometers thereon,
a recording module which records the data provided by the mixed reality glasses during the operation,
an analysis module which creates analysis results by processing the data recorded by the recording module, an evaluation module in which the data recorded with the recording module and the analysis results produced by the analysis module are displayed.

The structural and characteristic features of the present invention will be understood clearly by the following drawings and the detailed description made with reference to these drawings and therefore the evaluation shall be made by taking these figures and the detailed description into consideration.

### FIGURES CLARIFYING THE INVENTION

FIG. 1 is the representative view of the inventive system including mixed reality glasses with eye tracking and accelerometer.

### DESCRIPTION OF THE PART REFERENCES

1. Mixed reality glasses
1.1. Recording module
1.2. Analysis module
1.3. Evaluation module

### DETAILED DESCRIPTION OF THE INVENTION

In this detailed description, the preferred embodiments of the inventive system including a mixed reality glasses (1) with an eye tracker and accelerometer are described by means of examples only for clarifying the subject matter.

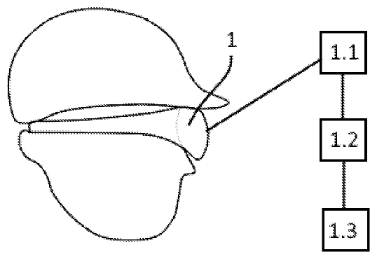

FIG. 1 is the representative view of the inventive system including the mixed reality glasses (1) with eye tracking and accelerometer. The system mainly comprises the mixed reality glasses (1), a recording module (1.1), an analysis module (1.2) and an evaluation module (1.3).

Mixed reality glasses (1) provides the operator's head position, head direction, eye hit position and eye gaze direction in X, Y and Z (3-dimensional vector) formats, which the analysis module (1.2) will use for the work study analysis with the sensors and accelerometers thereon. The operator performs the operation to be analyzed as it normally would after he/she puts on the mixed reality glasses (1) and runs the recording module (1.1) with the recording software installed. The recording module (1.1) records the data provided by the mixed reality glasses (1) during the operation.

The data recorded by the recording module (1.1) is processed by the analysis module (1.2) with the analysis software loaded, and the analysis result is created. The data recorded with the recording module (1.1) and the analysis results produced by the analysis module (1.2) are displayed with the evaluation module (1.3) loaded with the evaluation software.

In an alternative embodiment of the invention, the recording module (1.1), analysis module (1.2) and evaluation module (1.3) are on the mixed reality glasses (1).

In an alternative second embodiment of the invention, the recording module (1.1), analysis module (1.2) and evaluation module (1.3) can be found on a separate computer.

1. A system that enables the creation of a production process by recording and analyzing points that an operator focuses on with his eyes, and head position and head direction, the system comprising:
mixed reality glasses, which provide the operator's head position, head direction, eye position and eye gaze direction in X, Y and Z directions, with sensors and accelerometers thereon;
a recording module which records the data provided by the mixed reality glasses during the operation;
an analysis module, which creates analysis results by processing the data recorded by the recording module; and
an evaluation module in which the data recorded with the recording module and the analysis results produced by the analysis module are displayed.

2. System according to claim 1, wherein the mixed reality glasses have the recording module, the analysis module and the evaluation module thereon.

3. System according to claim 1, wherein the recording module, the analysis module and the evaluation module are provided on separate computers.
